(19) United States
(12) Patent Application Publication
(10) Pub. No.: US 2010/0089223 A1
(43) Pub. Date: Apr. 15, 2010

(54) Microphone set providing audio and text data

(76) Inventor: Waichi Ting, Monterey Park, CA (US)

Correspondence Address: WAICHI TING, UNIT 102 PMB380, 201 W. GARVEY AVE., MONTEREY PARK, CA, 91754, US

(21) Appl. No.: 12/287,906

(22) Filed: Oct. 14, 2008

(51) Int. Cl. G10H 1/36; H04R 11/04

(52) U.S. Cl. 84/610; 381/355

(57) ABSTRACT

The present invention is a microphone set which comprises a hand-hold microphone housing, a microphone, and a karaoke module received in the microphone housing. The karaoke module further comprises a voice input module, a data storage, a data processor, an audio output module, and a video output module. The present invention can use audio and text data to perform karaoke. The audio data is cheap and easy to obtain and doesn't need any process. The audio data can be downloaded or converted by the user. The text data is also very convenient to obtain. It can be edited or created by the user. Both the audio data and the text data are in small size for storing. The microphone set of the present invention is portable. It can selectively store a large amount of songs. It is convenient to use, and provides professional performance.

### BACKGROUND OF THE PRESENT INVENTION

1. Field of Invention

The present invention relates to a karaoke device, and more particularly to a karaoke microphone set providing music and text data.

2. Description of Related Arts

Karaoke is a form of entertainment. With the performance of karaoke equipment, an amateur singer can sing along with the music accompaniment. Basically, a karaoke equipment has a microphone for inputting singer's vocal signal, a mixer to mix the vocal signal with the music, and a output device to play the mixed audio signal for the singer and audient to listen. More complex karaoke system also provide video image to show on a screen as background. On the video the lyric is also shown to remind the singer. And the color of the word will change when it's time to sing it according to the rhythm.

Nowadays, karaoke equipments are getting more and more powerful. The quality of the audio/video signal is very good, more functions can be provided, the cost is also reduced. Right now it is much easier for people to have a set of karaoke system.

But there is an always existing problem which is obtaining the music accompaniment and the video with lyric. Both of the music and the video are specially processed and are not easy to obtain. Generally, the music accompaniment is from well-known pop songs but has the original singer's voice removed. So the user can only hear his/her own voice mixed with the music. The problem is not every song has this pure music accompaniment available. The music producer and publisher may not provide karaoke version of their songs, or not so soon. So the fact is, even though there are many karaoke version music of those most popular songs on the market, comparing to the amount of all the songs have ever being composed, and the speed of a song getting known and being forgotten, it's still difficult to find all your favorite music for karaoke.

Although some most popular songs have their karaoke version music on market, they are expensive. One of the reason is typically the music is sold on CD or DVD, the singer has to buy every song on the CD or DVD but he/she may only like to sing one song. For the video, the situation is the same. A karaoke VCD or DVD can provide good quality music and beautiful background image, as well as lyric reminding, but still it is expensive and the availability is limited. Another problem is the data size of the karaoke video is large, which is not suitable for portable device to store and play.

Also, the current using karaoke resources of music and video with lyric are not easy for user to edit. Especially the text information is not accessible or not editable. The user can not edit the lyric for the purposes such as translating the lyric into another language, or using his own lyric.

While on the other hand, nowadays downloadable music format, such as MP3, WAV is very popular. Almost every song has its MP3 version, and it is easy to convert from CD, and cheap to purchase from internet. To find the text of a lyric of a song from internet is also very simple. There are some software can help people sing karaoke with a computer. The problem is computers are not professional musical equipments, the performance is poor; it is not convenient to carry a computer to sing; and also, a computer is still expensive.

Now there is a need to develop an expert karaoke equipment which is portable, professional, and can utilize available music resources.

### SUMMARY OF THE PRESENT INVENTION

The main object of the present invention is to provide a karaoke equipment which can utilize easily accessable audio and text resources.

Another object of the present invention is to provide a karaoke equipment which displays text information or output text information.

Another object of the present invention is to provide a karaoke equipment which provides lyric reminding.

Another object of the present invention is to provide a karaoke equipment which is easy to provide music accompaniment.

Another object of the present invention is to provide a karaoke equipment which audio and text resources are downloadable from internet.

Another object of the present invention is to provide a karaoke equipment which audio and text resources can be created and edited by the users themselves.

Another object of the present invention is to provide a karaoke equipment which is portable.

Another object of the present invention is to provide a karaoke equipment which provides expert performance.

Another object of the present invention is to provide a karaoke equipment which costs less.

In order to accomplish the above objects, the present invention provides a microphone set providing audio and text data, comprising:

a hand-hold microphone housing;

a microphone received in the microphone housing for collecting user's voice; and

a karaoke module which is received in the microphone housing, comprising:

a voice input module which is connected with the microphone for inputting user's voice signal;

a data storage storing the audio data and the text data, wherein the audio data and the text data are correlated;

a data processor connected with the data storage for receiving the audio data and the text data, which further comprises: an audio processor which is connected with the data storage, wherein the audio processor is adapted to use said audio data to generate an audio signal, and mix the voice signal with the audio signal to form a sound signal, and a text processor which is connected with the data storage, wherein the text processor is adapted to use the text data correlated to the audio data to generate a text signal;

an audio output module which is connected with the audio processor for outputting the sound signal; and

a video output module which is connected with the text processor for outputting the text signal, wherein the sound signal and the text signal are synchronized.

### BRIEF DESCRIPTION OF THE DRAWINGS

FIG. 1 is a block diagram of a preferred embodiment of the present invention.

FIG. 2 is a schematic view of a preferred embodiment of the present invention.

FIG. 3 is a schematic view of an alternative embodiment of the present invention.

### DETAILED DESCRIPTION OF THE PREFERRED EMBODIMENT

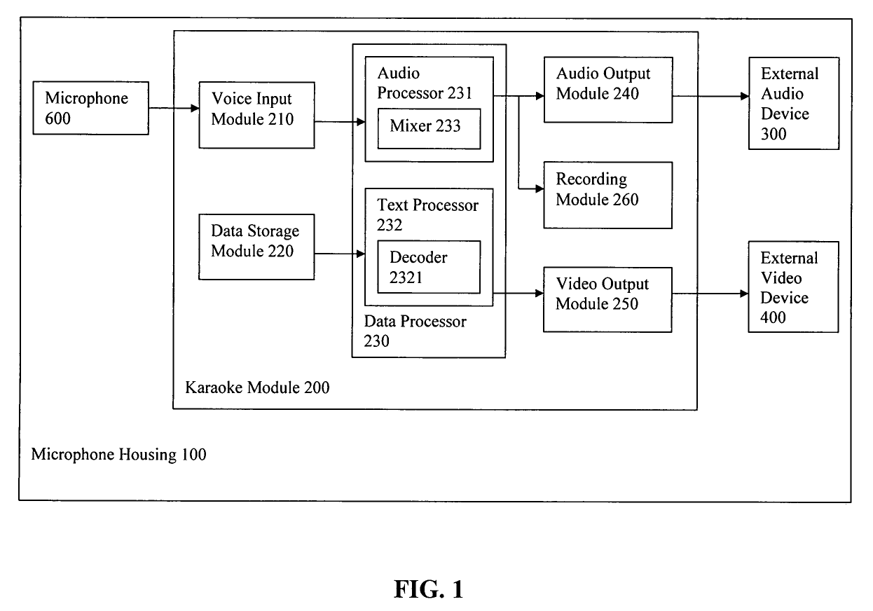

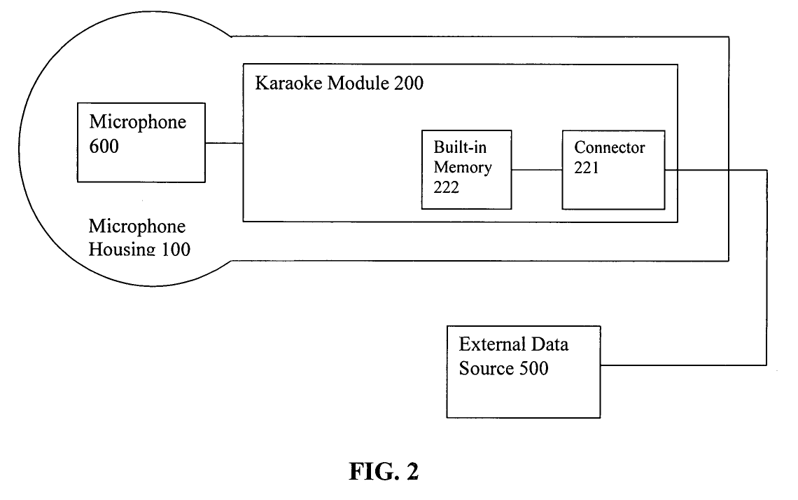

Referring to FIGS. 1 and 2, a microphone set of a preferred embodiment of the present invention comprises a hand-hold microphone housing 100, a microphone 600, and a karaoke module 200 received in the microphone housing. The karaoke module 200 further comprise a voice input module 210, a data storage 220, a data processor 230, an audio output module 240, and a video output module 250.

The microphone 600 is received inside the microphone housing 100, and is adapted to collect the user's voice signals. Particularly the voice signal is the user's singing voice. The voice input module 210 is connected with the microphone 600 for receiving the voice signal.

The data storage 220 is adapted to store audio and text data. The data storage 220 could be flash memory based media, or hard drive. The microphone set is able to modify the data stored in the data storage 220. In a preferred embodiment of the present invention, the data storage 220 is a SD card which is detachably attached to the microphone housing 100, and is communicatively connected with the karaoke module 200. Alternatively, the data storage 220 could be other media such as memory stick, and flash drive. The SD card is able to be detached from the microphone set is connected with a SD card reader/writer, or a computer with a SD card slot to download, upload and edit the audio and text data.

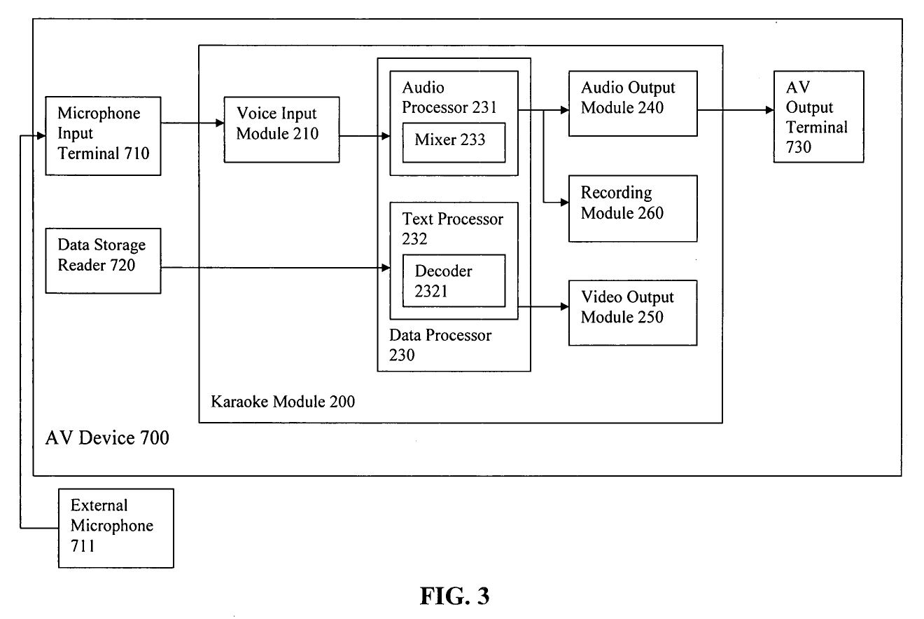

Referring to FIG. 3, in an alternative embodiment, the data storage 220 is a built-in memory 222. The built-in memory also has a connector 221 which is detachably linked with an external data source 500 and communicatively connected therewith. The external data source 500 could be a computer, a portable hard drive, or other data storage. The microphone set is able to download data from the external data source 500, and upload data to the external data source 500. Preferably, the built-in memory 222 further comprises a USB connector to communicatively connect with the external data source 500 though a USB cable.

The data processor 230 is connected with the data storage 220 for receiving the data stored therein. The data processor 230 further comprises an audio processor 231, and a text processor 232. The audio processor 231 is connected with the data storage 220 for receiving the audio data. Then the received audio data is formed into an accompaniment signal suitable to be music accompaniment for karaoke. The audio processor 231 is also connected with the voice input module 210 for receiving the voice signal. The audio processor 231 also comprises a mixer 233 for mixing the accompaniment signal with the digital voice signal to form a sound signal.

Preferably, each song provided by the microphone set is stored in a music file as the audio data. The music format which is able to be utilized by the audio processor 231 has a large range. Preferably, one of the suitable formats of the audio data is MP3. MP3 is a digital audio encoding format using a form of lossy data compression. This format is very popular, especially on internet and for portable electronics. Music of other format such as CD can easily be transformed into MP3 format. The data size for a normal song is several mega bytes in MP3 but still has acceptable sound quality. It is cheap and fast to download MPS songs from internet, and it can be downloaded song by song. Therefore, using MP3 format provides a lot of advantages. Alternatively, many other formats are also available in the present invention, for example, the WAV format, and midi format.

Still, not every MP3 or WAV song has the original singer's vocal signal removed. The audio processor 231 of the present invention further comprises a voice removing module to remove the original singer's vocal signal from the audio data. The voice removing module is using several methods to remove the original singer's vocal signal. In one method, the removing module compares the left and right channels of the audio data. Since generally the original singer's vocal track has the same signal at the left and right channels having the stereo effects that the singer is standing in the center. By comparing the left and right channel of the audio data, the removing module removes the same signals to achieve the vocal track removing. Another method is to mute or lower the volume of the human voice frequency which ranges from approximately 300 Hz to 3400 Hz. Also, these two methods can be cooperated together with technique such as Fast Fourier Transform to have a better effect. In this manner, the regular songs which are much easier to find than particular music for karaoke purpose, can be used with the present invention for karaoke.

The audio output module 240 is connected with the audio processor 231 for receiving the sound signal formed thereby. The audio output module 240 then output the received sound signal to an external audio device 300, such as an amplifier, a speaker set, or a TV set.

The text processor 232 is connected with the data storage 220 for receiving the text data. The receive text data is processed to form a text signal for display. Preferably, in the present invention the text data is the lyrics, and other information such as titles and original singer's names corresponding to the music stored as audio data in the data storage 220.

The video output module 250 is connected with the text processor 232 for receiving the text signal. In a preferred embodiment of the present invention, the video output module 250 also comprises a decoder 2321 to convert the digital text signal into analog text signal. Then the analog text signal is outputted to an external video device 400, preferably, a TV set. Alternatively, the digital text signal can be sent to a digital video device.

It is worth mentioning, the text data can be stored in the data storage 220 in various formats. In one method of storing in the present invention, each song provided by the microphone set has an individual file saving the text data of the song. The text data file and the corresponding music file (MP3, WAV, etc.) thereof are related. For example, the text data file and the corresponding music file have the same file name but different filename extension.

During playing karaoke, when a song is selected, the corresponding music file from the audio data is sent to the audio processor 231 for processing and finally showed by the external audio device 300. At the same time, the corresponding text file is sent to the text processor 232 for processing, and finally displayed by the external video device 400.

In an embodiment of the present invention, the text data, such as title and lyric can be displayed all together, or sentence by sentence at a predetermined speed. In an alternative embodiment, the displaying of the lyric is synchronized with the music. In this manner, the text data is saved with time information in the text file.

In a preferred embodiment of the present invention, one available format of the text file is LRC. LRC format is simple, each sentence has its time tag according to the correlated music. Following is an example of a LRC file:

[mm:ss.xx] lyrics line 1

[mm:ss.xx] lyrics line 2

. . .

[mm:ss.xx] last lyrics line

wherein mm is minutes, ss is seconds and xx is hundredths of a second.

Using the LRC files, the text processor 232 is able to send the text signal of a particular sentence to the video output module 250 according to the time tag assigned to the sentence. In one method, the lyric is displayed all together on a full screen. When it is time to sing a particular sentence, this sentence will be highlighted. Alternatively, each time only the sentence has to be sung is displayed at that particular time. Alternatively, the previous and after sentences together with the sentence has to be sung is displayed at that particular time.

It is easy for the users to create the LRC files by themselves. There are also some software can help users to create LRC files. The user is able to edit the text as will. So the users can use the microphone set of the present invention to show whatever the text they like, for example, the lyric in an alternative language. Also, not like an image file, the size of a LRC file is very small, which is very important for portable devices.

In an alternative preferred embodiment of the present invention, there is also file format which combine the audio data and corresponding graphic data in one file. The data processor 230 of the microphone set is able to decode the file of this particular format and process the audio data and graphic data simultaneously. Finally, both the audio signal and graphic signal are displayed synchronizedly.

In a preferred embodiment, the format of the file having both audio and grafic data is KAM. The data processor 230 can also process formats such as CD+G, MP3+G, and etc.

The microphone set further comprises a recording module 260 which is operatively linked to the audio output module 240 for recording the sound signal being output to the external audio device 300. With this function, the user can record his voice mixed with the music accompaniment at the same time when he is singing using the present invention.

The present invention also uses the karaoke module 200 as an embedded module which can be embedded in an AV device 700 which has a microphone input terminal 710 detachably connected with an external microphone 711, a data storage reader 720, and an AV output terminal 730 as a hardware expansion. In one embodiment, for example, the device is a DVD player, the data storage reader is a DVD reader, the karaoke module 200 comprises a voice input module 210, a data processor 230, an audio output module 240, and a video output module 250. Referring to FIG. 3, the voice input module 210 of the karaoke module 200 is connected with the microphone input terminal 710 for receiving sound signals from the external microphone 711. The data processor 230 of the karaoke module 200 is connected with the DVD reader 721 for receiving decoded audio and text data. The audio output module 240 and the video output module 250 are connected with the AV output terminal 730 for outputting the sound signal and the text signal. Alternatively, the device can also be a CD player, a MP3 player, a cell phone, or alike. With the karaoke module 200, it is very easy to expand the function of a current portable electronic device.

In summary, the present invention can use audio and text data to perform karaoke. The audio data is cheap and easy to obtain and doesn't need any process. The audio data can be downloaded or converted by the user. The text data is also very convenient to obtain. It can be edited or created by the user. Both the audio data and the text data are in small size for storing. The microphone set of the present invention is portable. It can selectively store a large amount of songs. It is convenient to use, and provides professional performance. The karaoke module 200 is also easy to embed into existing device for functional expansion.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A microphone set providing audio and text data, comprising:
a hand-hold microphone housing;
a microphone received in said microphone housing for collecting user's voice; and
a karaoke module which is received in said microphone housing, comprising:
a voice input module which is connected with said microphone for inputting user's voice signal;
a data storage storing said audio data and said text data, wherein said audio data and said text data are correlated;
a data processor connected with said data storage for receiving said audio data and said text data, which further comprises: an audio processor which is connected with said data storage, wherein said audio processor is adapted to use said audio data to generate an audio signal, and mix said voice signal with said audio signal to form a sound signal, and a text processor which is connected with said data storage, wherein said text processor is adapted to use said text data correlated to said audio data to generate a text signal;
an audio output module which is connected with said audio processor for outputting said sound signal; and
a video output module which is connected with said text processor for outputting said text signal, wherein said sound signal and said text signal are synchronized.

2. The microphone set, as recited in claim 1, wherein said text data comprises time information correlated to say audio data, wherein said text processor utilizes said time information to synchronize said text signal with said sound signal.

3. The microphone set, as recited in claim 2, wherein said audio data is stored in a music file in said data storage, said correlated text data is stored in a text file in said data storage, wherein said music file and said text file have a same file name, and different filename extension.

4. The microphone set, as recited in claim 3, wherein said text data is stored in file of LRC format.

5. The microphone set, as recited in claim 1, wherein said audio processor further comprises a voice removing module which is adapted to remove voice signal in said audio data.

6. The microphone set, as recited in claim 2, wherein said audio processor further comprises a voice removing module which is adapted to remove voice signal in said audio data.

7. The microphone set, as recited in claim 4, wherein said audio processor further comprises a voice removing module which is adapted to remove voice signal in said audio data.

8. The microphone set, as recited in claim 1, wherein said audio processor further comprises a recording module which is connected with said audio output module for lively recording said sound signal.

9. The microphone set, as recited in claim 4, wherein said audio processor further comprises a recording module which is connected with said audio output module for lively recording said sound signal.

10. The microphone set, as recited in claim 7, wherein said audio processor further comprises a recording module which is connected with said audio output module for lively recording said sound signal.

11. The microphone set, as recited in claim 1, wherein said data storage also stores an audio data and a correlated graphic data in one audio graphic file, wherein said microphone set further comprises an audio graphic module which is connected with said data storage for receiving said audio graphic file for further processing.

12. The microphone set, as recited in claim 9, wherein said data storage also stores an audio data and a correlated graphic data in one audio graphic file, wherein said microphone set further comprises an audio graphic module which is connected with said data storage for receiving said audio graphic file for further processing.

13. The microphone set, as recited in claim 10, wherein said data storage also stores an audio data and a correlated graphic data in one audio graphic file, wherein said microphone set further comprises an audio graphic module which is connected with said data storage for receiving said audio graphic file for further processing.

14. A karaoke module embedded in an AV device providing audio and text data, comprising:
a voice input module for inputting user's voice signal from said AV device;
a data processor connected with said AV device for receiving said audio data and said text data, which further comprises: an audio processor which is adapted to use said audio data to generate an audio signal, and mix said voice signal with said audio signal to form a sound signal, and a text processor which is adapted to use said text data correlated to said audio data to generate a text signal;
an audio output module which is connected with said audio processor for outputting said sound signal to said AV device; and
a video output module which is connected with said text processor for outputting said text signal said AV device, wherein said sound signal and said text signal are synchronized.

15. The karaoke module, as recited in claim 14, wherein said text data comprises time information correlated to say audio data, wherein said text processor utilizes said time information to synchronize said text signal with said sound signal.

16. The karaoke module, as recited in claim 15, wherein said audio data is stored in a music file in said data storage, said correlated text data is stored in a text file in said data storage, wherein said music file and said text file have a same file name, and different filename extension.

17. The karaoke module, as recited in claim 16, wherein said text data is stored in file of LRC format.

18. The karaoke module, as recited in claim 14, wherein said audio processor further comprises a voice removing module which is adapted to remove voice signal in said audio data.

19. The karaoke module, as recited in claim 15, wherein said audio processor further comprises a voice removing module which is adapted to remove voice signal in said audio data.

20. The karaoke module, as recited in claim 16, wherein said audio processor further comprises a voice removing module which is adapted to remove voice signal in said audio data.
